(19) United States
(12) Patent Application Publication
(10) Pub. No.: US 2026/0193394 A1
(43) Pub. Date: Jul. 9, 2026

(54) COPOLYMER FOR ANION EXCHANGE MEMBRANE AND ANION EXCHANGE MEMBRANE INCLUDING THE SAME

(71) Applicant: SK INNOVATION CO., LTD., Seoul (KR)

(72) Inventors: Jong Chan KIM, Daejeon (KR); Dong Gun LEE, Daejeon (KR); So Young LEE, Daejeon (KR); Soo Min CHO, Daejeon (KR); Cheol Woo KIM, Daejeon (KR); Jung A LEE, Daejeon (KR)

(21) Appl. No.: 19/437,329

(22) Filed: Dec. 31, 2025

(30) Foreign Application Priority Data
Jan. 7, 2025 (KR) 10-2025-0002431

(51) Int. Cl. C08F 214/18; B01J 41/14

(52) U.S. Cl. CPC C08F 214/186; B01J 41/14

(57) ABSTRACT

A copolymer suitable for use in an anion exchange membrane and an anion exchange membrane including the same are provided. The copolymer includes a repeating unit represented by Formula 1. In Formula 1, M1 is selected from arylene groups represented by Formulae 2-1 and 2-2, and M2 is an arylene group represented by Formula 3. Variables x and y are each independently in a range of 0.1 to 0.9, with the sum of x and y being 1. L1 and L2 are each independently selected from arylene groups represented by Formulae 4-1 and 4-2, as defined herein.

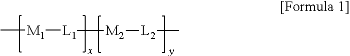

### CROSS-REFERENCE TO RELATED APPLICATION

This patent application claims priority to and the benefit of Korean Patent Application No. 10-2025-0002431 filed on Jan. 7, 2025, and all the benefits accruing therefrom under 35 U.S.C. § 119, the content of which is incorporated by reference herein in its entirety.

### BACKGROUND

### 1. Technical Field

The embodiments of the present disclosure relate generally to a copolymer for an anion exchange membrane and an anion exchange membrane including the copolymer.

### 2. Description of Related Art

An electrolyte membrane refers to a membrane having ionic conductivity and selectively transporting ions during an electrochemical reaction. The electrolyte membrane is used in fields such as fuel cells and water electrolysis devices.

Among electrolyte membranes, an anion exchange membrane selectively transports anions and is used in fields such as fuel cells or electrochemical reduction of carbon dioxide. These devices often operate under elevated temperature and/or pressure conditions, so that improved thermal and mechanical properties of the anion exchange membrane may be required.

Research and development have been conducted to improve the physical properties of the anion exchange membrane, such as stability, durability, and ionic conductivity.

### SUMMARY

An embodiment of the present disclosure provides a copolymer for an anion exchange membrane having improved chemical stability and ionic conductivity.

Another embodiment of the present disclosure provides an anion exchange membrane having improved ionic conductivity, mechanical properties, and reliability.

A copolymer for an anion exchange membrane according to embodiments of the present disclosure includes a repeating unit represented by Formula 1 below:

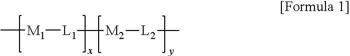

In Formula 1, M₁ is selected from the arylene groups represented by any one of Formulae 2-1 and 2-2 below, M₂ is an arylene group represented by Formula 3 below, x and y are each independently 0.1 to 0.9 and x+y=1, and L₁ and L₂ are each independently selected from the arylene groups represented by Formulae 4-1 and 4-2 below.

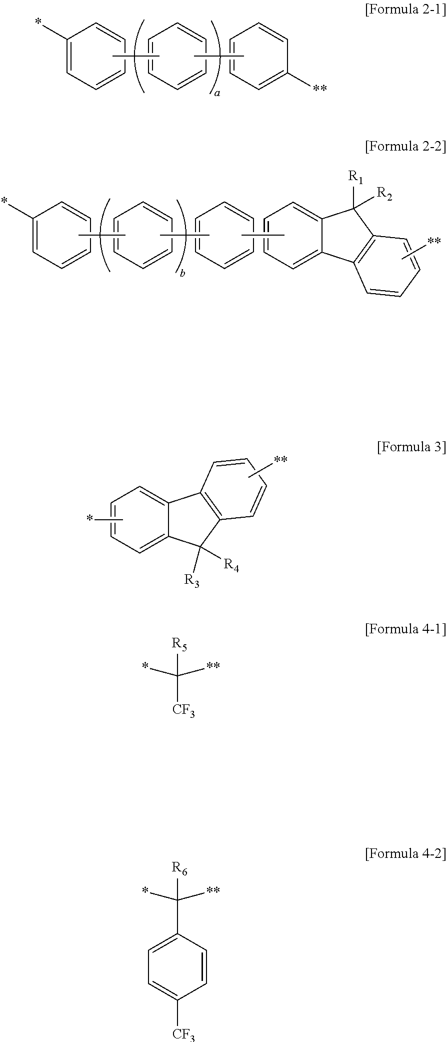

In Formulae 2-1, 2-2, 3, 4-1, and 4-2, a is an integer of 2 to 6, b is an integer of 0 to 4, R₁ and R₂ are each independently a C₁-C₁₀ alkyl group, R₃ and R are each independently a C₃-C₁₀ alkyl group having a quaternary ammonium salt at a terminal, R₅ and R₆ are each independently selected from —H and a C₁-C₃ alkyl group, and -* and -*′ represent crosslinked bonding sites.

In some embodiments, in Formula 2-1, a may be an integer of 2 to 5, and in Formula 2-2, b may be an integer of 0 to 3.

In some embodiments, the divalent phenylene groups in Formulae 2-1 and 2-2 may each independently be bonded at a meta- or a para-position.

In some embodiments, the counterion of the quaternary ammonium salt may be a halide anion, OH⁻, or HCO₃⁻.

In some embodiments, M₁ may be selected from the arylene groups represented by any one of Formulae 2-1A to 2-1E below:

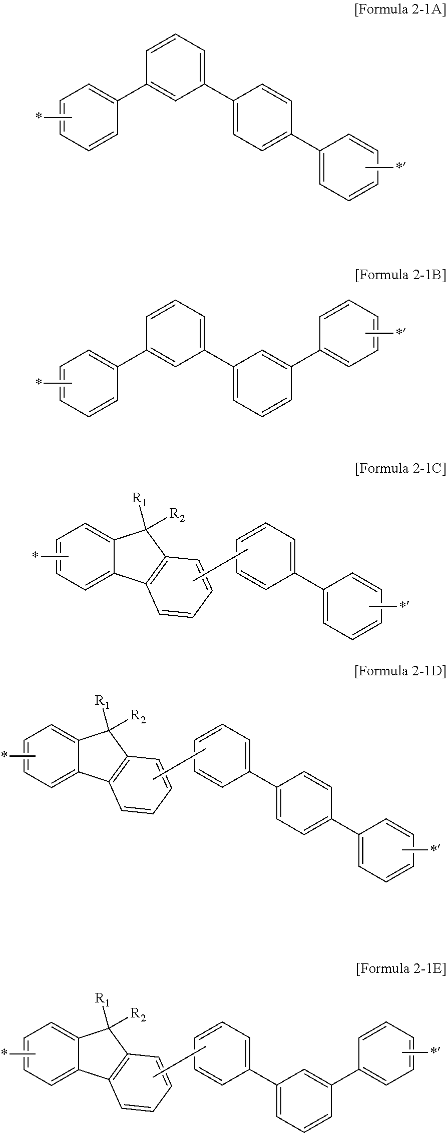

In Formulae 2-1A to 2-1E, R₁ and R₂ are each independently a C₁-C₁₀ alkyl group, and -* and -*′ represent crosslinked bonding sites.

In some embodiments, in Formulae 2-1C to 2-1E, the arylene group derived from fluorene may be bonded at the meta-position with respect to the adjacent phenylene group.

In some embodiments, R₁ and R₂ may each independently be a C₁-C₅ alkyl group.

In some embodiments, R₃ and R₄ may each independently be a C₄-C₇ alkyl group having a halide quaternary ammonium salt at a terminal.

In some embodiments, the quaternary ammonium salt may be selected from the group represented by Formulae 5-1 to 5-3 below:

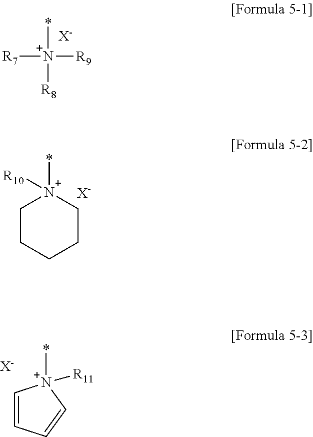

In Formulae 5-1 to 5-3, R₇ to R₁₁ are each independently a C₁-C₅ alkyl group, each X is independently O, F, Cl, Br, or I, and -* represents a bonding site bonded to the terminal of R₃ or R₄.

In some embodiments, the copolymer for an anion exchange membrane may further include a crosslinking unit represented by any one of Formulae 6-1 and 6-2 below:

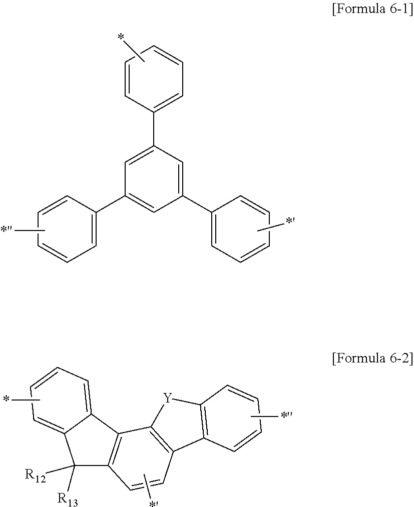

In Formulae 6-1 and 6-2, -*, -*′ and -*″ represent bonding sites crosslinked with the repeating unit, R₁₂ and R₁₃ are each independently a C₁-C₅ alkyl group, and Y is O or S.

In some embodiments, the repeating unit and the crosslinking unit may be directly crosslinked or may be crosslinked through an arylene group represented by any one of Formulae 7-1 and 7-2 below:

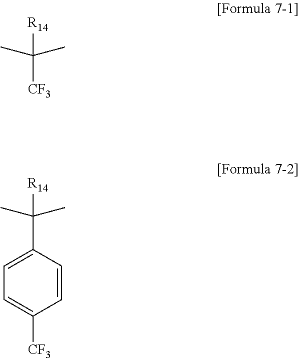

In Formulae 7-1 and 7-2, R₁₄ and R₁₅ are each independently selected from —H and C₁-C₃ alkyl groups, and -* and -*′ represent crosslinked bonding sites.

In some embodiments, the copolymer may include the repeating unit represented by Formula 1 in an amount of 90.0 mol % to 100 mol %, based on the total repeating units included in the copolymer.

In some embodiments, the copolymer for an anion exchange membrane may include the repeating unit represented by Formula 1 in an amount of 80.0 mol % to 99.0 mol %, based on the total repeating units included in the copolymer, and may include the crosslinking unit represented by any one of Formulae 6-1 and 6-2 in an amount of 1.0 mol % to 20.0 mol %, based on the total repeating units included in the copolymer.

In some embodiments, the copolymer for an anion exchange membrane may have a weight average molecular weight of 30,000 g/mol to 2,000,000 g/mol.

In some embodiments, the ionic conductivity reduction rate (R) of the copolymer for the anion exchange membrane, calculated by Equation 1 below, may be 15% or less:

$$Ionic conductivity reduction rate ( R , \% ) = ( ( {C}_{1} - {C}_{2} ) / {C}_{1} ) \times 100 \qquad [ Equation 1 ]$$

In Equation 1, C₁ denotes the ionic conductivity evaluated at room temperature for an anion exchange membrane including the copolymer for an anion exchange membrane, after converting the counterion to OH⁻, and C₂ denotes the ionic conductivity evaluated at room temperature after immersing the anion exchange membrane in the OH⁻ form in a 1 M alkaline solution, maintaining it at 80° C. for 28 days, and then cooling it to room temperature.

An anion exchange membrane according to embodiments of the present disclosure includes the above-described copolymer.

In some embodiments, the anion exchange membrane may have a thickness of 10 μm to 80 μm.

In some embodiments, the OH⁻ ionic conductivity measured at room temperature for the copolymer for the anion exchange membrane may be 30 mS/cm or more.

The copolymer according to embodiments of the present disclosure may achieve improved chemical stability, physical stability, and ionic conductivity.

The anion exchange membrane according to embodiments of the present disclosure may achieve improved ion-exchange characteristics, high-temperature stability, and operational stability.

The copolymer and anion exchange membrane of the present disclosure may be applied to technical fields such as membrane electrode assemblies, fuel cells including alkaline fuel cells, water electrolysis devices, carbon dioxide conversion devices, and electrochemical hydrogen compression systems.

### DETAILED DESCRIPTION

Hereinafter, embodiments of the present disclosure will be described in detail with reference to the accompanying drawing so that those skilled in the art may easily practice the embodiments. However, these embodiments are merely illustrative, and the embodiments of the present disclosure are not limited to the embodiments described herein.

### Copolymer for an Anion Exchange Membrane

The copolymer for an anion exchange membrane according to embodiments of the present disclosure includes a repeating unit represented by Formula 1 below:

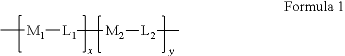

In Formula 1, M₁ is selected from the arylene groups represented by any one of Formulae 2-1 and 2-2 below, M₂ is an arylene group represented by Formula 3 below, x and y are each independently 0.1 to 0.9 and satisfy x+y=1, and L₁ and L₂ are each independently selected from the arylene groups represented by Formulae 4-1 and 4-2 below.

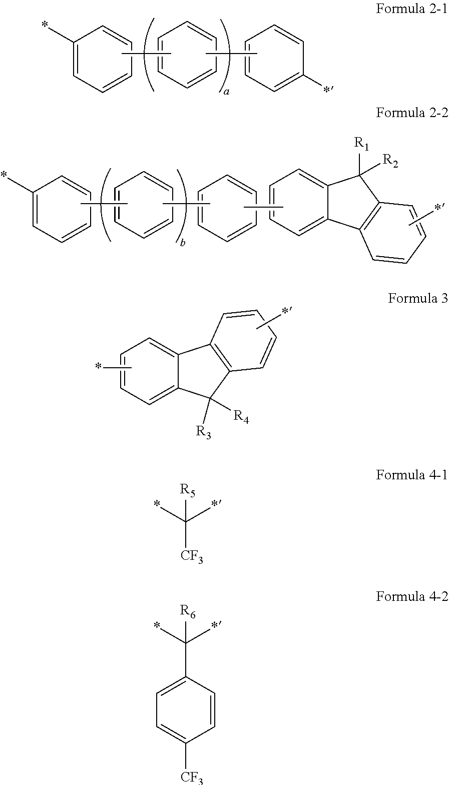

In Formulae 2-1, 2-2, 3, 4-1, and 4-2, a is an integer of 2 to 6, b is an integer of 0 to 4, and R₁ and R₂ are each independently a C₁-C₁₀ alkyl group. The alkyl group may be, for example, a straight-chain alkyl group.

R₃ and R₄ are each independently a C₃-C₁₀alkyl group having a quaternary ammonium salt at a terminal. The alkyl group may be, for example, a straight-chain alkyl group.

R₅ and R₆ are each independently selected from —H and a C₁-C₃ alkyl group.

The symbols -* and -*′ represent crosslinked bonding sites.

The ionic conductivity, chemical stability, and physical stability of the copolymer for an anion exchange membrane may be improved. Also, the anion exchange membrane including the copolymer may achieve improved ion-exchange characteristics, high-temperature stability, and operational stability.

In some embodiments, the copolymer may be a random copolymer or a block copolymer. For instance, in one embodiment, the copolymer is a random copolymer.

In some embodiments, in Formula 2-1, the “a” may be an integer of 2 to 5, and in Formula 2-2, the “b” may be an integer of 0 to 3. For example, the “a” may be 2 or 3, and the “b” may be 0 or 1.

In some embodiments, the divalent phenylene groups in Formulae 2-1 and 2-2 may each independently be bonded at the meta- or para-position.

In some embodiments, the counterion of the quaternary ammonium salt may be a halide anion, OH⁻, or HCO₃⁻. The halide anion may be selected from F⁻, Cl⁻, Br⁻, and I⁻.

In some embodiments, M₁ may be selected from the arylene groups represented by any one of Formulae 2-1A to 2-1E below:

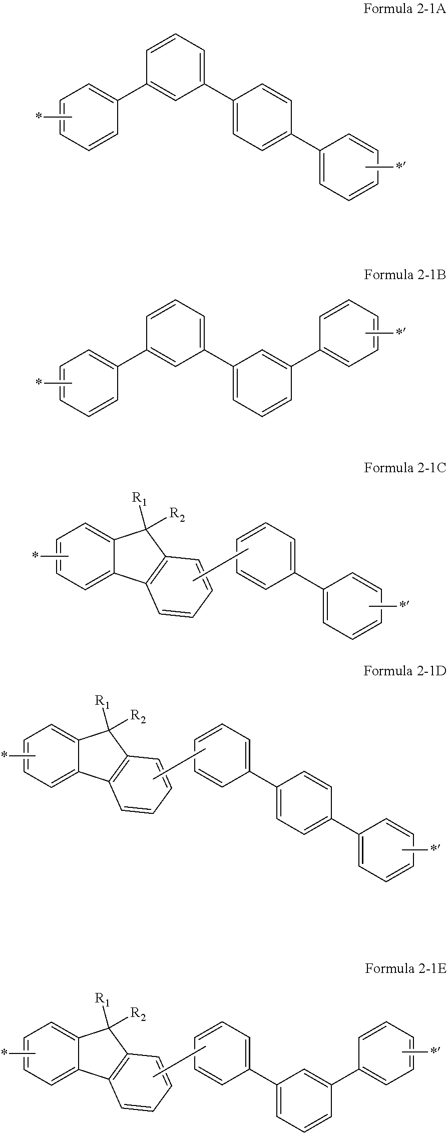

In Formulae 2-1A to 2-1E, R₁ and R₂ are each independently a C₁-C₁₀ alkyl group, and the -* and -*′ represent crosslinked bonding sites. The alkyl group may be, for example, a straight-chain alkyl group.

In some embodiments, R₁ and R₂ may be the same.

R₁ and R₂ may be, for example, a C₁-C₇ straight-chain alkyl group.

In some embodiments, in Formulae 2-1C to 2-1E, the arylene group derived from fluorene may be bonded at the meta-position with respect to the adjacent phenylene group.

For example, the arylene group derived from fluorene may be bonded to the adjacent phenylene group at the position indicated by 4 below. For example, the adjacent phenylene group may be bonded to the 1-, 2-, or 3-position of the arylene group derived from fluorene.

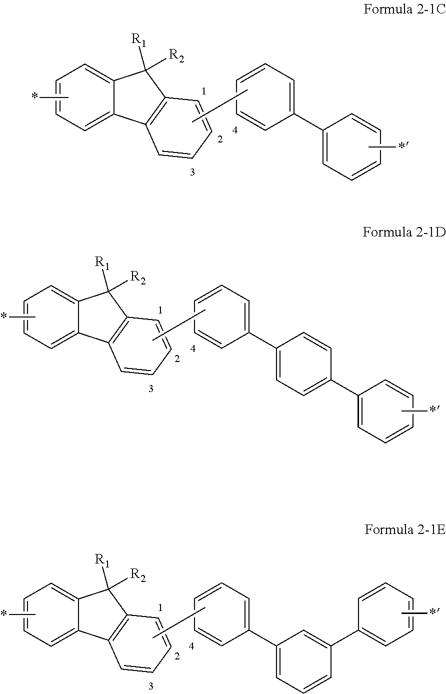

In some embodiments, R₁ and R₂ may each independently be a C₁-C₅ alkyl group, for example, a C₁-C₃ alkyl group.

In some embodiments, R₃ and R₄ may each independently be a C₄-C₇ alkyl group having a halide quaternary ammonium salt at a terminal.

In some embodiments, the quaternary ammonium salt may be an alkylammonium salt, or an alicyclic or aromatic ammonium salt containing one or two nitrogen atoms.

The alicyclic or aromatic ammonium salt may be, for example, an ammonium salt of pyrrolidine, piperidine, pyrrole, pyridine, or imidazole.

In some embodiments, the quaternary ammonium salt may be selected from the group represented by Formulae 5-1 to 5-3 below.

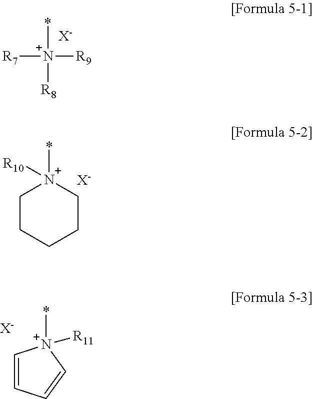

In Formulae 5-1 to 5-3, R₇ to R₁₁ are each independently a C₁-C₅ alkyl group, each X is independently OH, F, Cl, Br, or I, and -* represents a bonding site bonded to the terminal of R₃ or R₄. The alkyl group may be, for example, a straight-chain alkyl group.

In some embodiments, the copolymer for an anion exchange membrane may further include a crosslinking unit represented by any one of Formulae 6-1 and 6-2 below:

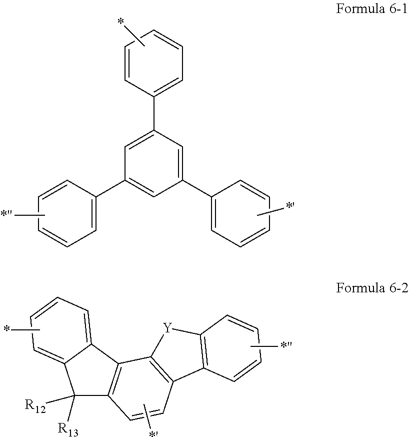

In Formulae 6-1 and 6-2, -*, -*′ and -*″ represent bonding sites crosslinked with the repeating unit, R₁₂ and R₁₃ are each independently a C₁-C₅ alkyl group, and Y is O or S. The alkyl group may be, for example, a straight-chain alkyl group.

The copolymer may be a random copolymer or a block copolymer. In an embodiment, the copolymer may be a random copolymer.

In some embodiments, the repeating unit and the crosslinking unit may be directly crosslinked or may be crosslinked through an arylene group represented by any one of Formulae 7-1 and 7-2 below:

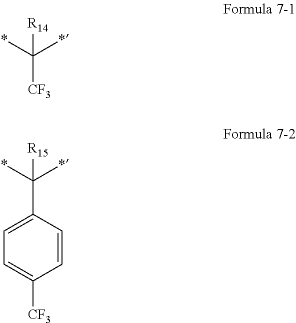

In Formulae 7-1 and 7-2, R₁₄ and R₁₅ are each independently selected from —H and C₁-C₃ alkyl groups, and -* and -*′ represent crosslinked bonding sites.

In some embodiments, the copolymer for an anion exchange membrane may include the repeating unit represented by Formula 1. For example, the copolymer for an anion exchange membrane may include the repeating unit represented by Formula 1 in an amount of 90.0 mol % to 100 mol %, or 90.0 mol % to 99.9 mol %, based on the total repeating units included in the copolymer.

In some embodiments, the copolymer for an anion exchange membrane may include the repeating unit represented by Formula 1 and the crosslinking unit represented by any one of Formulae 6-1 and 6-2. For example, the copolymer for an anion exchange membrane may include the repeating unit represented by Formula 1 in an amount of 80.0 mol % to 99.0 mol %, 90.0 mol % to 99.0 mol %, or 90.0 mol % to 95.0 mol %, based on the total repeating units included in the copolymer, and may include the crosslinking unit represented by any one of Formulae 6-1 and 6-2 in an amount of 1.0 mol % to 20.0 mol %, 1.0 mol % to 10.0 mol %, or 5.0 mol % to 10.0 mol %. These compositional ranges may lead to an improved high-temperature stability of the anion exchange membrane. Furthermore, by selecting the above compositional ranges, improved processability may be ensured during membrane manufacturing or casting.

In some embodiments, the copolymer for an anion exchange membrane may have a weight average molecular weight of 30,000 g/mol to 2,000,000 g/mol. For example, the weight-average molecular weight (Mw) may be measured by gel permeation chromatography (GPC) in accordance with ISO 16014 or ASTM D5296.

In some embodiments, the reduction rate (R) of the ionic conductivity of the copolymer for an anion exchange membrane, calculated by Equation 1 below, may be 15% or less. Accordingly, the high-temperature stability of the copolymer for an anion exchange membrane may be further improved.

$$Ionic conductivity reduction rate ( R , \% ) = ( ( {C}_{1} - {C}_{2} ) / {C}_{1} ) \times 100 \qquad Equation 1$$

In Equation 1, C₁ denotes the ionic conductivity evaluated at room temperature for an anion exchange membrane including the copolymer for an anion exchange membrane, after converting the counterion to OH⁻, and C₂ denotes the ionic conductivity evaluated at room temperature after immersing the anion exchange membrane in the OH⁻ form in a 1 M alkaline solution, maintaining it at 80° C. for 28 days, and then cooling it to room temperature.

The ionic conductivity may be calculated based on the membrane resistance (Ω) measured by a 4-point probe method using an impedance analyzer (VSP-3e, Biologics) in the frequency range of 0.1 kHz to 1 MHz, for example, by disposing the anion exchange membrane in the OH— form between Pt electrodes.

The alkaline solution may be, for example, a KOH solution, a NaOH solution, or the like.

In some embodiments, the ionic conductivity reduction rate (R) for an anion exchange membrane may be, for example, 10% or less, 7% or less, 5% or less, or 4% or less.

Accordingly, the high-temperature stability of the copolymer for an anion exchange membrane may be further improved.

In a non-limiting embodiment; the copolymer for an anion exchange membrane may be synthesized by a preparation method including for example, mixing and stirring at least one of first monomers and at least one of second monomers, and then mixing and stirring the mixture with a third monomer. The mixing and stirring may be performed at 0° C. under an inert gas atmosphere, such as nitrogen, but is not limited thereto. A solution in which the polymerization reaction of the above-described monomers is completed may be added to, for example, methanol or the like to precipitate a solid, which may then be filtered, washed, and dried to obtain a solid precursor of the copolymer. For example, when mixing the third monomer, an acid such as trifluoromethanesulfonic acid may be mixed together.

The first monomer may include, for example, Monomer a and/or Monomer b below.

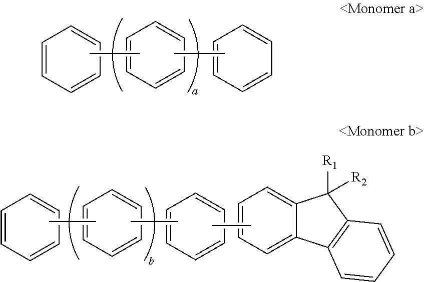

The second monomer may include, for example, Monomer c below.

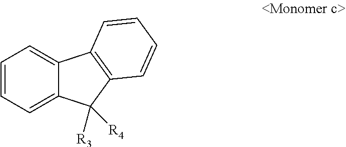

The third monomer may include, for example, Monomers d and/or e below.

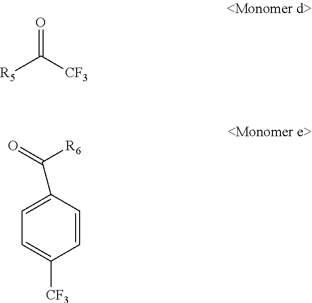

In the first to third monomers, a, b, and R₁ to R₆ refer to the definitions as defined in Formula 1.

The third monomer may be included as a linker connecting the first and second monomers within the copolymer for an anion exchange membrane.

For example, the copolymer for an anion exchange membrane may be synthesized by dissolving the copolymer precursor in a solvent, slowly adding and stirring a tertiary amine aqueous solution thereto.

For example, a solvent such as diethyl ether may be added to a solution including the copolymer to precipitate a solid, which may then be filtered, washed, and dried to obtain a solid copolymer precursor.

### Anion Exchange Membrane

Another embodiment of the present disclosure is directed to an anion exchange membrane which includes the above-described copolymer. Accordingly, the anion exchange membrane may achieve improved ionic conductivity, mechanical properties, high-temperature stability, and reliability.

In a non-limiting embodiment, the anion exchange membrane may be manufactured by dissolving the above-described copolymer for an anion exchange membrane in an organic solvent to obtain a first solution, filtering the first solution to remove impurities to obtain a second solution, casting the second solution on a substrate such as a glass plate, drying and separating the membrane.

The first solution may be formed at a concentration of for example, 15 wt % to 35 wt %. The drying may be performed, for example, in a vacuum oven at a temperature of 80° C. to 100° C.

In some embodiments, the exchange membrane is ion conductive having an OH⁻ ionic conductivity measured at room temperature of 30 mS/cm or more, and/or wherein the copolymer is included at 80 wt % or more, preferably 90 wt % or more, and more preferably 95 wt %, and even more preferably 99 wt % or more with respect to a weight of a total polymer content of the anion exchange membrane, and/or wherein the anion exchange membrane has a thickness of 10 μm to 80 μm, more preferably of 25 μm to 80 μm and even more preferably of 40 μm to 80 μm in a dry state under ambient conditions at room temperature and room pressure. In some embodiments, the anion exchange membrane may have a thickness of, for example, 10 μm to 80 μm. Preferably, the anion exchange membrane has a thickness of 25 μm to 80 μm. More preferably, the anion exchange membrane has a thickness of 40 μm to 80 μm. The thickness may be referred to as a thickness in a dry state under ambient conditions (room temperature and room pressure, that is 25° C. and 1 bar).

In some embodiments, the OH⁻ ionic conductivity of the anion exchange membrane measured at room temperature for the copolymer for the anion exchange membrane may be 30 mS/cm or more. Accordingly, the anion exchange membrane may achieve sufficient ionic conductivity.

In some embodiments, the anion exchange membrane may be ion conductive having an OH⁻ ionic conductivity measured at room temperature of 30 mS/cm or more. Preferably, the OH⁻ ionic conductivity of the anion exchange membrane including and/or being composed of the copolymer for the anion exchange membrane described above, may be 30 mS/cm or more when measured at room temperature. The copolymer itself may show ion conductive properties and thus may be referred to as an ion conductive copolymer. Accordingly, the anion exchange membrane may achieve sufficient ionic conductivity, that is, may enable efficient ion transport across the polymer structure such as a selective transport of anions while blocking other ions (cations, in particular, and neutral molecules).

In some embodiments, wherein the ionic conductivity reduction rate (R), calculated by Equation 1 below, is 15% or less:

$$Ionic conductivity reduction rate ( R , \% ) = ( ( {C}_{1} - {C}_{2} ) / {C}_{1} ) \times 100 \qquad [ Equation 1 ]$$

in Equation 1, C₁ and C₂ respectively denote the ionic conductivity of the ion exchange membrane evaluated at room temperature after converting the counterion of the copolymer included in the anion exchange membrane to OH⁻ and after immersing the anion exchange membrane in the OH form in a 1 M alkaline solution, maintaining it at 80° C. for 28 days, and then cooling it to room temperature, preferably wherein the alkaline solution is KOH. Reference may be made to the above-described explanation regarding Equation 1.

For example, the OH⁻ ionic conductivity at room temperature may be 40 mS/cm or more, or 50 mS/cm or more, and 100 mS/cm or less.

A fuel cell according to embodiments of the present disclosure includes the above-described anion exchange membrane.

The fuel cell may include a cathode; an anode disposed opposite the cathode; and the anion exchange membrane disposed between the cathode and the anode.

The fuel cell may be, for example, a solid alkaline fuel cell (SAFC).

A water electrolysis device according to embodiments of the present disclosure includes the above-described anion exchange membrane. The water electrolysis device may include, for example, the anion exchange membrane; and an electrode material disposed on the anion exchange membrane, wherein the electrode material may include, for example, a transition metal, a binder, a porous material, and the like.

A carbon dioxide conversion device according to embodiments of the present disclosure includes the above-described anion exchange membrane. The carbon dioxide conversion device may include, for example, a cathode; an anode disposed opposite the cathode; and the anion exchange membrane disposed between the cathode and the anode. When carbon dioxide is supplied to the cathode and a voltage is applied to the carbon dioxide conversion device, carbon dioxide may be reduced according to the following reaction scheme: 3CO₂₂+H₂+2e⁻→CO+2HCO₃⁻. The anion exchange membrane may be inserted into a membrane electrode assembly (MEA) to prevent deterioration of the carbon dioxide conversion performance of the cathode due to the accumulation of hydrogen ions (H) on the surface of the cation exchange membrane.

Hereinafter, embodiments of the present disclosure will be further described with reference to specific experimental examples. However, the examples and comparative examples included in the experimental examples are provided merely for illustrative purposes of the embodiments and are not intended to limit the scope of the appended claims.

### Synthesis Examples

Monomers 1 to 5 below were synthesized and used for the preparation of copolymers in the examples and comparative examples.

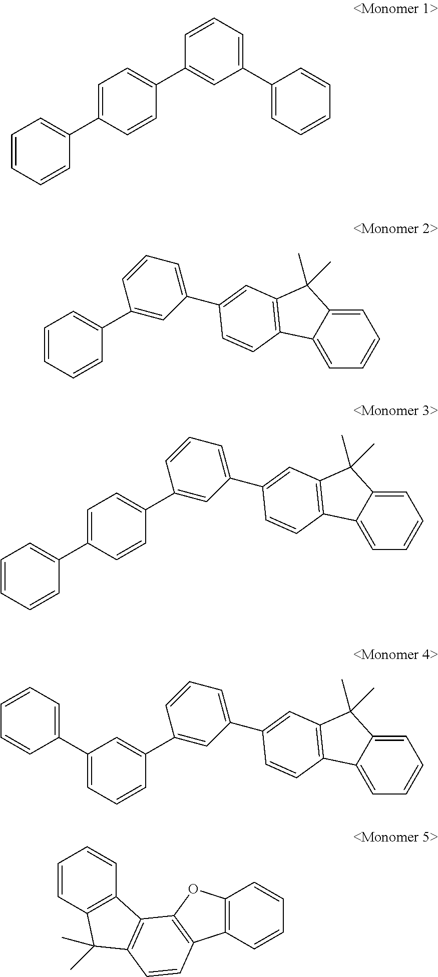

### Synthesis Example 1: Synthesis of Monomer 1

[00145]3-Bromo-1,1′:4′,1″-terphenyl (5.0 g 16.2 mmol), phenylboronic acid (2.4 g, 19.4 mmol), and tetrahydrofuran (80 mL) were added to a 250 mL two-necked round-bottom flask and stirred to prepare a mixed solution. An aqueous solution (13.4 mL) containing tetrakis(triphenylphosphine)palladium(0) (0.4 g, 0.3 mmol) and potassium carbonate (6.7 g 48.5 mmol) was added, and the mixture was stirred at 65° C. for 8 hours. After stirring, the mixture was cooled to room temperature and extracted with ethyl acetate (100 mL) and water (50 mL). The aqueous layer was removed using a separatory funnel, and the organic solvent layer was further washed with water (50 mL). The aqueous layer was then separated and removed. The organic solvent layer was dried over anhydrous magnesium sulfate, filtered, and concentrated under reduced pressure. The product was purified by silica gel column chromatography with dichloromethane/n-hexane (5:95 volume ratio), yielding 3.0 g of the final monomer 1 as a white solid.

The results of ¹H-Nuclear Magnetic Resonance (H-NMR) spectroscopy of monomer 1 are as follows:

¹H-NMR (CDCl₃, ppm): 7.88-7.87 (t, 1H), 7.77-7.72 (m, 4H), 7.70-7.68 (m, 4H), 7.67-7.61 (m, 2H), 7.58-7.55 (t, 1H), 7.52-7.48 (td, 4H), 7.42-7.38 (q, 2H)

### Synthesis Example 2: Synthesis of Monomer 2

2-(3-Bromophenyl)-9,9-dimethyl-9H-fluorene (3.0 g 8.6 mmol), phenylboronic acid (1.3 g, 10.3 mmol), and tetrahydrofuran (43 mL) were added to a 100 mL two-necked round-bottom flask and stirred to prepare a mixed solution. To the prepared mixed solution, an aqueous solution (7.1 mL) containing Tetrakis(triphenylphosphine)palladium(0)(0.2 g 0.2 mmol) and potassium carbonate (3.6 g 25.8 mmol) was added, and the mixture was stirred at 65° C. for 8 hours. After stirring, the mixture was cooled to room temperature, and ethyl acetate (80 mL) and water (40 mL) were added to perform extraction. The aqueous layer was removed through a separatory funnel, and the organic solvent layer was additionally washed with water (40 mL), and then the aqueous layer was separated and removed. The organic solvent layer was dried over anhydrous magnesium sulfate, filtered, and concentrated under reduced pressure. The product was purified by silica gel column chromatography with ethyl acetate/n-hexane (5:95 volume ratio) to obtain 2.4 g of the final monomer 2 as a white solid.

The results of ¹H-Nuclear Magnetic Resonance (¹H-NMR) spectroscopy analysis performed on the monomer 2 are as follows:

¹H-NMR (CDCl₃, ppm): 7.91-7.90 (t, 1H), 7.85-7.84 (d, 1H), 7.81-7.79 (dd, 1H), 7.73 (m, 2H), 7.71 (s, 1H), 7.70-7.66 (td, 2H), 7.63-7.61 (m, 1H), 7.59-7.56 (t, 1H), 7.54-7.49 (q, 3H), 7.44-7.36 (m, 3H), 1.59 (s, 6H)

### Synthesis Example 3: Synthesis of Monomer 3

2-(3-Bromophenyl)-9,9-dimethyl-9H-fluorene (3.1 g 8.6 mmol), 4-Biphenylboronic acid (2.1 g, 10.3 mmol), and Tetrahydrofuran (43 mL) were added and stirred to prepare a mixed solution. An aqueous solution (7.1 mL) containing Tetrakis(triphenylphosphine)palladium(0) (0.2 g 0.2 mmol) and Potassium carbonate (3.6 g, 25.8 mmol) was added to the prepared mixed solution, and the mixture was stirred at 65° C. for 8 hours. After stirring, the mixture was cooled to room temperature, and ethyl acetate (80 mL) and water (40 mL) were added to perform extraction. The aqueous layer was removed through a separatory funnel, and the organic solvent layer was additionally washed with water (40 mL), and then the aqueous layer was separated and removed. The organic solvent layer was dried over anhydrous magnesium sulfate, filtered, and concentrated under reduced pressure. The product was purified by silica gel column chromatography with dichloromethane/n-hexane (5:95 by volume) to obtain 2.6 g of the final monomer 3 as a white solid.

The results of ¹H-Nuclear Magnetic Resonance (1H-NMR) spectroscopy analysis performed on the monomer 3 are as follows:

¹H-NMR (CDCl₃, ppm): 7.94-7.93 (t, 1H), 7.85-7.83 (d, 1H), 7.80-7.78 (d, 3H), 7.75-7.73 (m, 3H), 7.71-7.65 (m, 51H), 7.60-7.57 (t, 1H), 7.52-7.47 (m, 3H), 7.42-7.35 (m, 3H), 1.58 (s, 61H)

### Synthesis Example 4: Synthesis of Monomer 4

In a 100 mL two-necked round-bottom flask, 2-(3-Bromophenyl)-9,9-dimethyl-9H-fluorene (3.1 g, 8.6 mmol) and 3-Biphenylboronic acid (1.4 g, 6.9 mmol), Tetrahydrofuran (30 mL) was added and stirred to prepare a mixed solution. An aqueous solution (4.8 mL) containing Tetrakis(triphenylphosphine)palladium(0)(0.1 g, 0.1 mmol) and Potassium carbonate (2.4 g 17.2 mmol) was added to the prepared mixed solution, and the mixture was stirred at 65° C. for 8 hours. After stirring it was cooled to room temperature and extracted with ethyl acetate (70 mL) and water (35 mL). The aqueous layer was removed through a separatory funnel, and the organic solvent layer was additionally washed with water (35 mL), and then the aqueous layer was separated and removed. The organic solvent layer was dried over anhydrous magnesium sulfate, filtered, and concentrated under reduced pressure. The product was purified by silica gel column chromatography with dichloromethane/n-hexane (5:95 volume ratio) to obtain 1.3 g of the final monomer 4 as a white solid.

The results of ¹H-Nuclear Magnetic Resonance (¹H-NMR) spectroscopy for the monomer 4 are as follows:

¹H-NMR (CDCl₃, ppm): 7.95-7.91 (d, 2H), 7.88-7.78 (dd, 2H), 7.67-6.64 (m, 8H), 7.61-7.57 (m, 2H), 7.52-7.49 (m, 3H), 7.43-7.36 (m, 3H), 1.58 (s, 6H)

### Synthesis Example 5: Synthesis of Monomer 5

### (1) Synthesis of Intermediate Compound 5-1

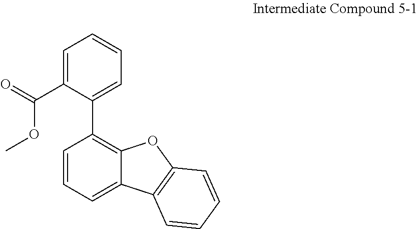 [SMILES: COC(=O)c1ccccc1-c1cccc2c1oc1ccccc12]

Dibenzofuran-4-boronic acid (5.0 g 23.6 mmol), methyl 2-bromobenzoate (6.1 g, 28.3 mmol), and tetrahydrofuran (120 mL) were added to a 500 mL two-necked round-bottomed flask and stirred to prepare a mixed solution. An aqueous solution (19.6 mL) containing tetrakis(triphenylphosphine)palladium(0)(0.5 g, 0.5 mmol) and potassium carbonate (9.8 g, 70.8 mmol) was added to the prepared mixed solution, and the mixture was stirred at 65° C. for 8 hours. After stirring, the mixture was cooled to room temperature and extracted with ethyl acetate (100 mL) and water (50 mL). The aqueous layer was removed through a separatory funnel, and the organic solvent layer was additionally washed with water (50 mL), and then the aqueous layer was separated and removed. The organic layer was dried over anhydrous magnesium sulfate, filtered, and concentrated under reduced pressure. The product was purified by silica gel column chromatography with n-hexane/ethyl acetate (5:95 volume ratio), yielding 6.0 g of colorless liquid intermediate compound 5-1.

The results of ¹H-Nuclear Magnetic Resonance (¹H-NMR) spectroscopy of intermediate compound 5-1 are as follows:

¹H-NMR (CDCl₃, ppm): 8.09-8.03 (d, 1H), 8.01-7.98 (m, 2H) 7.69-7.67 (m, 1H), 7.66 (d, 1H), 7.61-7.52 (m, 2H), 7.48-7.44 (m, 3H), 7.39-7.37 (t, 1H), 3.52 (s, 3H)

### (2) Synthesis of Intermediate Compound 5-2

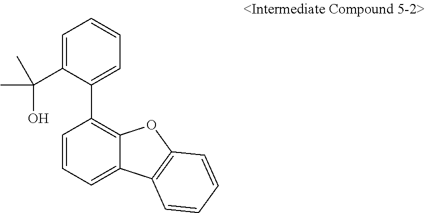 [SMILES: CC(C)(O)c1ccccc1-c1cccc2c1oc1ccccc12]

Intermediate compound 5-1 (5.7 g 18.9 mmol) and tetrahydrofuran (75 mL) were added to a 250 mL two-necked round-bottom flask and stirred to prepare a solution. The solution was cooled to 0° C. in a cooling water bath, and the solution was stirred at 0° C. under a nitrogen atmosphere. 19 mL (56.6 mmol) of a 3M methyl magnesium bromide in tetrahydrofuran solution was slowly added and stirred at room temperature for 8 hours. After stirring the mixture was cooled to 0° C. again and water (10 mL) was added to terminate the reaction. Saturated ammonium chloride aqueous solution (20 mL) and ethyl acetate (50 mL) were then added, and the aqueous layer was removed through a separatory funnel. The organic solvent layer was further washed with water (50 mL) and then separated and removed. The organic solvent layer was dried over anhydrous magnesium sulfate, filtered, and concentrated under reduced pressure. 5.7 g of intermediate compound 5-2 as a white solid was obtained without further purification.

The results of ¹H-Nuclear Magnetic Resonance (¹H-NMR) spectroscopy analysis of the intermediate compound 5-2 are as follows:

¹H-NMR (CDCl₃, ppm): 8.03-7.99 (m, 2H), 7.83-7.81 (m, 1H), 7.53-7.37 (m, 7H), 7.26-7.24 (m, 1H), 1.89 (br, 1H), 1.53 (s, 3H), 1.43 (s, 3H)

### (3) Synthesis of Monomer 5

Intermediate compound 5-2 (5.5 g 18.2 mmol) and dichloromethane (60 mL) were added to a 250 mL two-necked round-bottom flask and stirred to prepare a solution. The solution was cooled to 0° C. in a cooling water bath, and the solution was stirred at 0° C. under a nitrogen atmosphere Boron trifluoride etherate (2.6 g 18.2 mmol) was slowly added and stirred at room temperature for 8 h. After stirring, the mixture was cooled to 0° C. again and water (10 mL) was added to terminate the reaction. Saturated sodium bicarbonate aqueous solution (20 mL) and dichloromethane (50 mL) were then added. The aqueous layer was removed through a separatory funnel, and the organic solvent layer was further washed with water (50 mL). The aqueous layer was separated and removed. The organic solvent layer was dried over anhydrous magnesium sulfate, filtered, and concentrated under reduced pressure. The product was purified by silica gel column chromatography with dichloromethane/n-hexane (5:95 volume ratio) to obtain 4.5 g of final monomer 5.

The results of ¹H-Nuclear Magnetic Resonance (1H-NMR) spectroscopy analysis performed on the monomer 5 are as follows:

¹H-NMR (CDCl₃, ppm): 8.82-8.80 (d, 1H), 8.01-8.03 (d, 1H), 7.96-7.94 (d, 1H), 7.71-7.73 (d, 1H), 7.54-7.47 (m, 4H), 7.46-7.39 (m, 2H), 1.61 (s, 6H)

### Example 1 (Copolymer 1A)

### (1) Preparation of Precursor of Copolymer 1A

Monomer 1 (0.20 g 0.65 mmol), 9,9-bis(6-bromohexyl)-9H-fluorene (0.32 g 0.65 mmol), and dichloromethane (3.5 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.18 mL, 1.96 mmol) and trifluoromethanesulfonic acid (1.6 mL, 17.70 mmol) were then added. The resulting mixture was stirred at 0° C. for 2 hours, and the viscous solution was poured into methanol (100 mL) to precipitate a solid. The precipitated solid was filtered, washed twice with 50 mL of methanol, and dried in an oven to obtain 0.67 g of the precursor of Copolymer 1A.

The results of gel permeation chromatography (GPC) performed on the precursor of Copolymer 1A are as follows: The GPC analysis was conducted using a Shodex KF-805L column with an Agilent 1260 HPLC system. Tetrahydrofuran (THF) was used as the eluent at a flow rate of 0.5 mL/min, and the analysis was performed at a column temperature of 40° C.

Mn 1.99×10⁴ g/mol, Mw 2.32×10⁵ g/mol

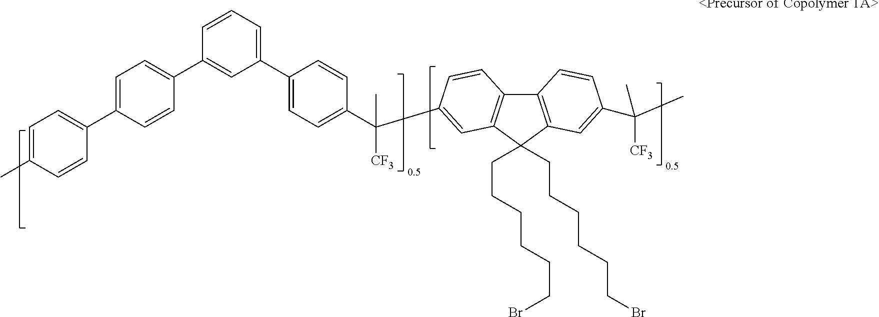

### (2) Preparation of Copolymer 1A

The precursor of Copolymer 1A (0.67 g) and N-methyl-2-pyrrolidone (6.5 mL) were added to a 25 mL round-bottom flask and stirred to prepare a solution. After the precursor of Copolymer 1A was completely dissolved, a 43% aqueous trimethylamine solution (1.1 mL) was slowly added. The mixture was stirred at room temperature for 24 hours, and the solution was poured into diethyl ether (100 mL) to precipitate a solid. The precipitated solid was filtered, washed twice with 50 mL of diethyl ether, and dried in an oven to obtain 0.76 g of Copolymer 1A.

Copolymer 1A includes the repeating unit represented by Formula 1A below.

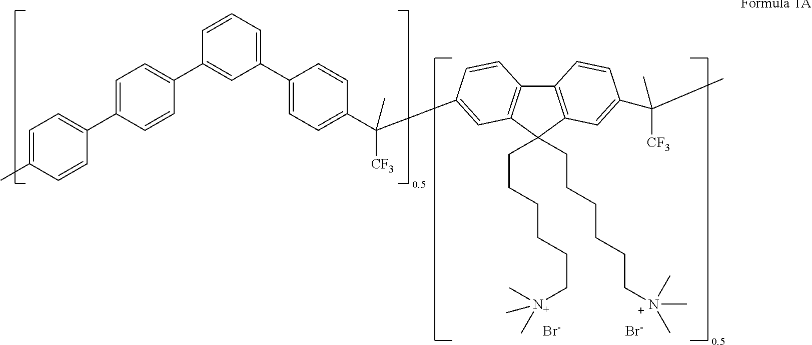

### Example 2 (Copolymer 1B)

### (1) Preparation of Precursor of Copolymer 1B

Monomer 1 (0.16 g 0.52 mmol), 9,9-bis(6-bromohexyl)-9H-fluorene (0.39 g 0.78 mmol), and dichloromethane (4.0 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.18 mL, 1.96 mmol) and trifluoromethanesulfonic acid (1.3 mL, 14.75 mmol) were then added. The resulting mixture was stirred at 0° C. for 1 hour, and the viscous solution was poured into methanol (100 mL) to precipitate a solid. The precipitated solid was filtered, washed twice with 50 mL of methanol, and dried in an oven to obtain 0.65 g of a Copolymer 1B precursor.

The results of gel permeation chromatography (GPC) performed on the precursor of Copolymer 1B are as follows:

Mn 1.78×10⁴ g/mol, Mw 1.94×10⁵ g/mol

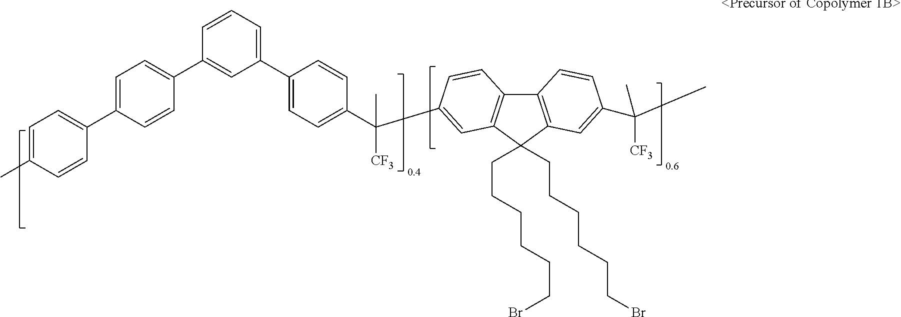

### (2) Preparation of Copolymer 1B

The precursor of Copolymer 1B (0.65 g) and N-methyl-2-pyrrolidone (6.5 mL) were added to a 25 mL round-bottom flask and stirred to prepare a solution. After the precursor of Copolymer 1B was completely dissolved, a 43% aqueous trimethylamine solution (1.3 mL) was slowly added. The mixture was stirred at room temperature for 24 hours and then poured into diethyl ether (100 mL) to precipitate a solid. The precipitated solid was filtered, washed twice with 50 mL of diethyl ether, and dried in an oven to obtain 0.70 g of Copolymer 1B.

Copolymer 1B includes the repeating unit represented by Formula 1B below.

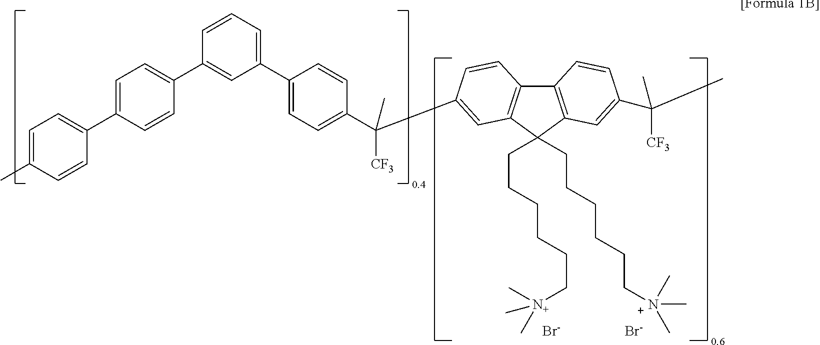

### Example 3 (Copolymer 1C)

(1) Preparation of precursor of Copolymer 1C

Monomer 2 (0.17 g 0.49 mmol), 9,9-bis(6-bromohexyl)-9H-fluorene (0.36 g 0.74 mmol), and dichloromethane (3.0 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.16 mL, 1.84 mmol) and trifluoromethanesulfonic acid (1.5 mL, 16.63 mmol) were then added. The resulting mixture was stirred at 0° C. for 2 hours, and the viscous solution was poured into methanol (100 mL) to precipitate a solid. The precipitated solid was filtered, washed twice with 50 mL of methanol, and dried in an oven to obtain 0.65 g of the precursor of Copolymer 1C.

The results of gel permeation chromatography (GPC) performed on the precursor of Copolymer 1C are as follows:

$$Mn 1.93 \times {10}^{4} g / mol , Mw 1.84 \times {10}^{6} g / mol$$

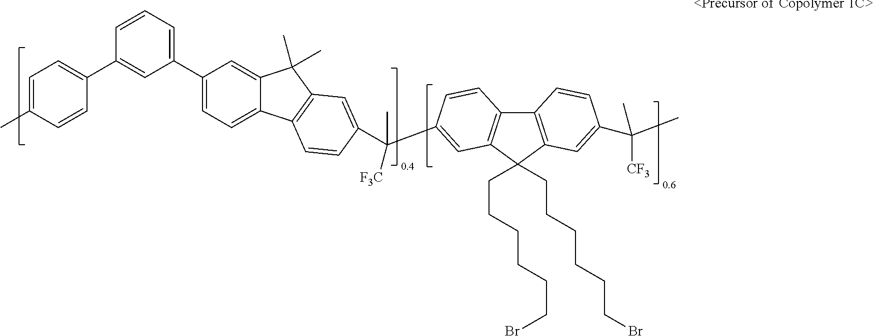

### (2) Preparation of Copolymer 1C

The precursor of Copolymer 1C (0.65 g) and N-methyl-2-pyrrolidone (16.4 mL) were added to a 25 mL round-bottom flask and stirred to prepare a solution. After the precursor of Copolymer 1C was completely dissolved, a 43% aqueous trimethylamine solution (1.2 mL) was slowly added. The mixture was stirred at room temperature for 48 hours and then poured into diethyl ether (100 mL) to precipitate a solid. The precipitated solid was filtered, washed twice with 50 mL of diethyl ether, and dried in an oven to obtain 0.63 g of Copolymer 1C.

Copolymer 1C includes the repeating unit represented by Formula 1C below.

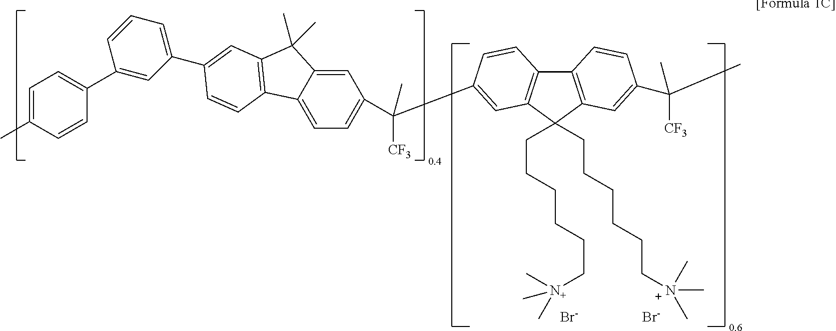

### Example 4 (Copolymer 1D)

### (1) Preparation of Precursor of Copolymer 1D

Monomer 3 (0.20 g 0.47 mmol), 9,9-bis(6-bromohexyl)-9H-fluorene (0.54 g 1.10 mmol), and dichloromethane (9.5 mL) were added to a 25 mL round-bottom flask and stirred to prepare a solution. The solution was cooled to 0° C. using a cooling water bath, and the solution was stirred at 0° C. under a nitrogen atmosphere. 1,1,1-trifluoroacetone (0.21 mL, 2.37 mmol) and trifluoromethanesulfonic acid (0.4 mL, 4.46 mmol) were then added. The resulting mixture was stirred at 0° C. for 2 hours, and the viscous solution was poured into methanol (100 mL) to precipitate a solid. The precipitated solid was filtered, washed twice with 50 mL of methanol, and dried in an oven to obtain 0.89 g of the precursor of Copolymer 1D.

The results of gel permeation chromatography (GPC) performed on the precursor of Copolymer 1D are as follows:

$$Mn 2.01 \times {10}^{4} g / mol , Mw 9.2 \times {10}^{4} g / mol$$

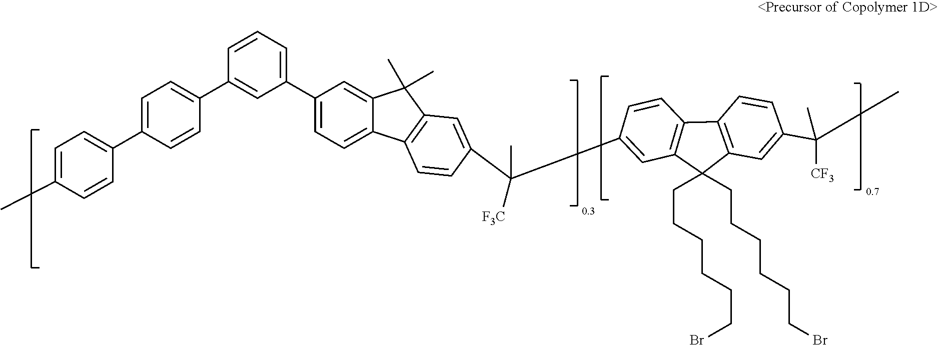

### (2) Preparation of Copolymer 1D

The precursor of Copolymer 1D (0.89 g) and dimethylformamide (8.0 mL) were added to a 25 mL round-bottom flask and stirred to prepare a solution. After the precursor of Copolymer 1D was completely dissolved, a 43% aqueous trimethylamine solution (1.5 mL) was slowly added. The mixture was stirred at room temperature for 48 hours and then poured into diethyl ether (100 mL) to precipitate a solid. The precipitated solid was filtered, washed twice with 50 mL of diethyl ether, and dried in an oven to obtain 1.04 g of Copolymer 1D.

Copolymer 1D includes the repeating unit represented by Formula 1D below.

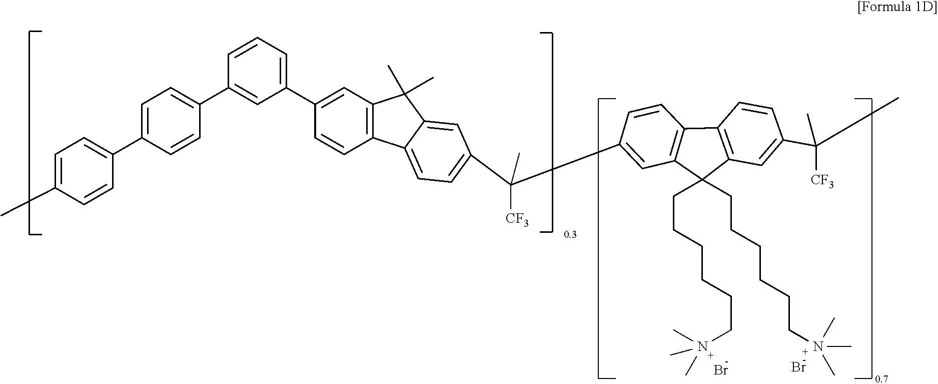

### Example 5

### (1) Preparation of Precursor of Copolymer 1E

Monomer 3 (0.15 g 0.35 mmol), 9,9-bis(6-bromohexyl)-9H-fluorene (0.41 g 0.83 mmol), Monomer 5 (0.03 g 0.09 mmol), and dichloromethane (7.1 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.16 mL, 1.77 mmol) and trifluoromethanesulfonic acid (0.3 mL, 2.67 mmol) were then added. The resulting mixture was stirred at 0° C. for 7 hours, and the viscous solution was poured into methanol (100 mL) to precipitate a solid. The precipitated solid was filtered, washed twice with 50 mL of methanol, and dried in an oven to obtain 0.70 g of the precursor of Copolymer 1E.

The results of gel permeation chromatography (GPC) performed on the precursor of Copolymer 1E are as follows:

$$Mn 2.12 \times {10}^{4} g / mol , Mw 2.68 \times {10}^{5} g / mol$$

The precursor of Copolymer 1E includes the crosslinking unit represented by Formula 1E and the repeating unit represented by Formula 1E-1 below, and x=0.28, y=0.65, z=0.07.

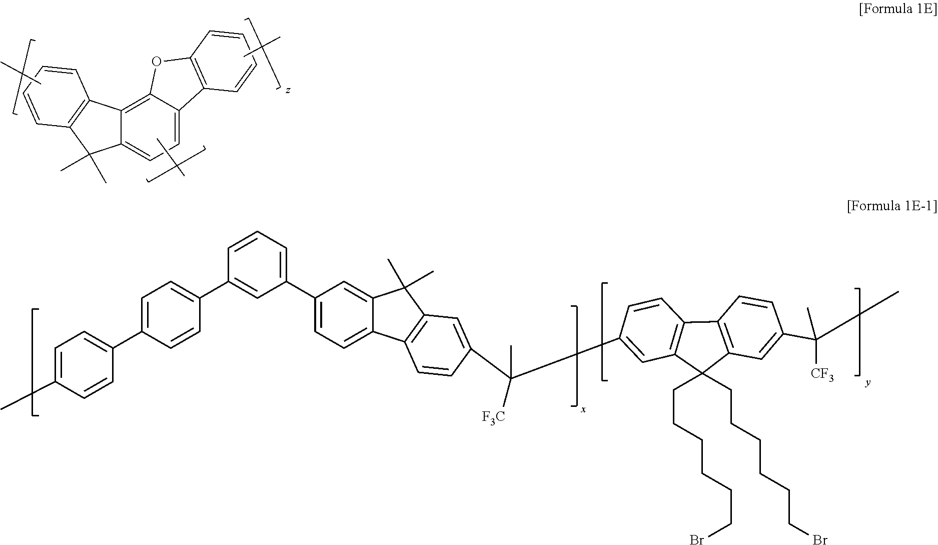

### (2) Preparation of Copolymer 1E

The precursor of Copolymer 1E (0.70 g), dimethylformamide (6.0 mL), and N-methyl-2-pyrrolidone (6.0 mL) were added to a 25 mL round-bottom flask and stirred to prepare a solution. After the precursor of Copolymer 1E was completely dissolved, a 43% aqueous trimethylamine solution (1.1 mL) was slowly added. The mixture was stirred at room temperature for 48 hours and then poured into diethyl ether (100 mL) to precipitate a solid. The precipitated solid was filtered, washed twice with 50 mL of diethyl ether, and dried in an oven to obtain 0.78 g of Copolymer 1E.

Copolymer 1E includes the crosslinking unit represented by Formula 1E and the repeating unit represented by Formula 1E-2 below, and x=0.28, y=0.65, z=0.07. The crosslinking unit represented by Formula 1E and repeating unit represented by Formula 1E-2 may be directly crosslinked or may be crosslinked through a methylene group derived from 1,1,1-trifluoroacetone.

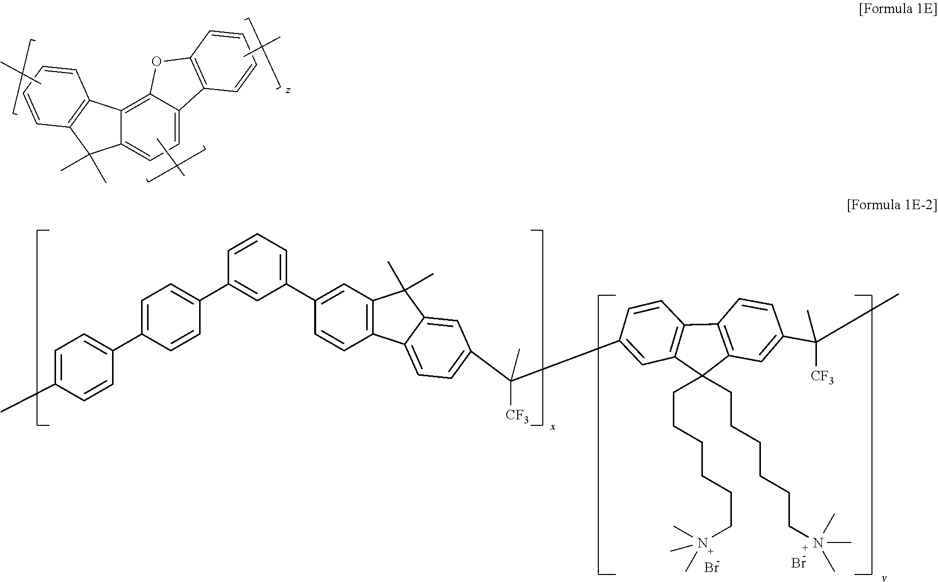

### Example 6 (Copolymer 1F)

### (1) Preparation of Precursor of Copolymer 1F

Monomer 3 (0.15 g 0.35 mmol), 9,9-bis(6-bromohexyl)-9H-fluorene (0.41 g 0.83 mmol), 1,3,5-triphenylbenzene (0.02 g, 0.06 mmol), and dichloromethane (7.1 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.16 mL, 1.77 mmol) and trifluoromethanesulfonic acid (0.3 mL, 2.67 mmol) were then added. The resulting mixture was stirred at 0° C. for 6 hours, and the viscous solution was poured into methanol (100 mL) to precipitate a solid. The precipitated solid was filtered, washed twice with 50 mL of methanol, and dried in an oven to obtain 0.64 g of the precursor of Copolymer 1F.

The results of gel permeation chromatography (GPC) performed on the Copolymer 1F precursor are as follows:

$$Mn 2.58 \times {10}^{4} g / mol , Mw 1.1 \times {10}^{6} g / mol$$

The precursor of Copolymer 1F includes the crosslinking unit represented by Formula 1F and the repeating unit represented by Formula 1F-1 below, and x=0.29, y=0.67, z=0.05.

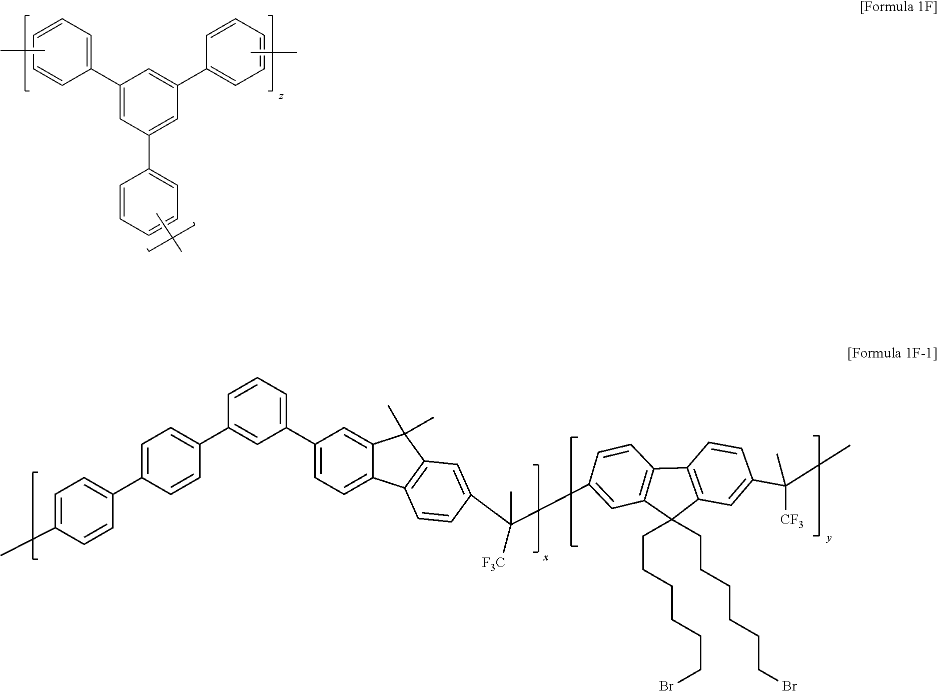

### (2) Preparation of Copolymer 1F

The precursor of Copolymer 1F (0.64 g), dimethylformamide (3.0 mL), and N-methyl-2-pyrrolidone (7.0 mL) were added to a 25 mL round-bottom flask and stirred to prepare a solution. After the precursor of Copolymer 1F was completely dissolved, a 43% aqueous trimethylamine solution (1.1 mL) was slowly added. The mixture was stirred at room temperature for 48 hours and then poured into diethyl ether (100 mL) to precipitate a solid. The precipitated solid was filtered, washed twice with 50 mL of diethyl ether, and dried in an oven to obtain 0.77 g of Copolymer 1F.

Copolymer 1F includes the crosslinking unit represented by Formula 1F and the repeating unit represented by Formula 1F-2 below, and x=0.29, y=0.67, z=0.05. The crosslinking unit represented by Formula 1F and the repeating unit represented by Formula 1F-2 may be directly crosslinked or may be crosslinked through a methylene group derived from 1,1,1-trifluoroacetone.

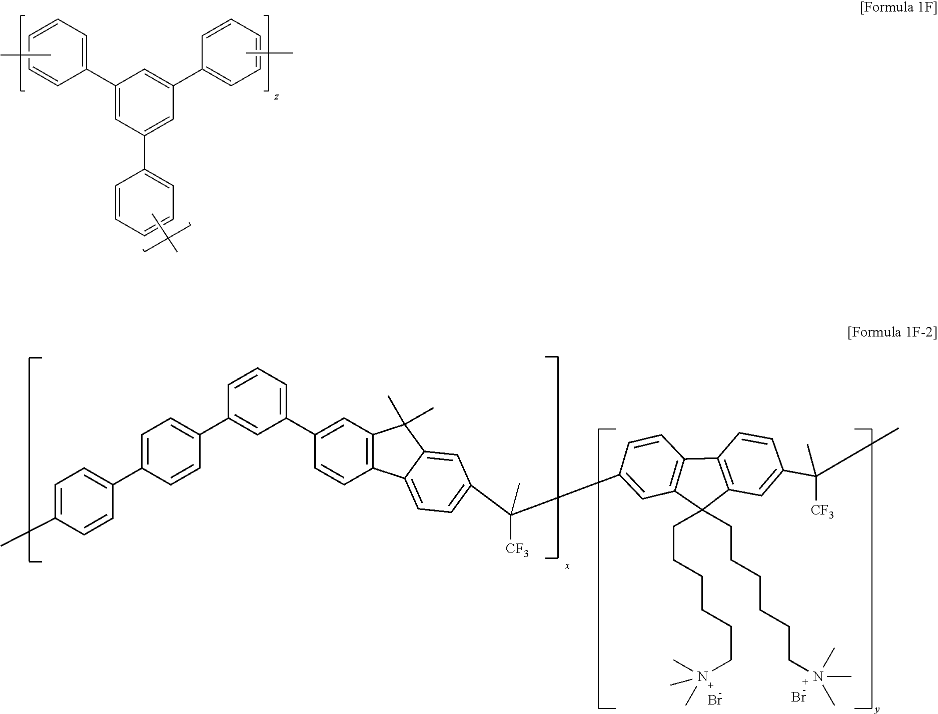

### Example 7 (Copolymer 1G)

### (1) Preparation of Precursor of Copolymer 1G

Monomer 4 (0.25 g 0.59 mmol), 9,9-bis(6-bromohexyl)-9H-fluorene (0.68 g 1.38 mmol), and dichloromethane (9.9 mL) were added to a 25 mL round-bottom flask and stirred to prepare a solution. The solution was cooled to 0° C. in a cooling water bath, and the solution was stirred at 0° C. under a nitrogen atmosphere. 1,1,1-trifluoroacetone (0.26 mL, 2.96 mmol) and trifluoromethanesulfonic acid (0.5 mL, 5.57 mmol) were then added. The resulting mixture was stirred at 0° C. for 7 hours, and the viscous solution was poured into methanol (100 mL) to precipitate a solid. The precipitated solid was filtered, washed twice with 50 mL of methanol, and dried in an oven to obtain 1.19 g of the precursor of Copolymer 1G.

The results of gel permeation chromatography (GPC) performed on the precursor of Copolymer 1G are as follows:

$$Mn 1.86 \times {10}^{4} g / mol , Mw 1.26 \times {10}^{5} g / mol$$

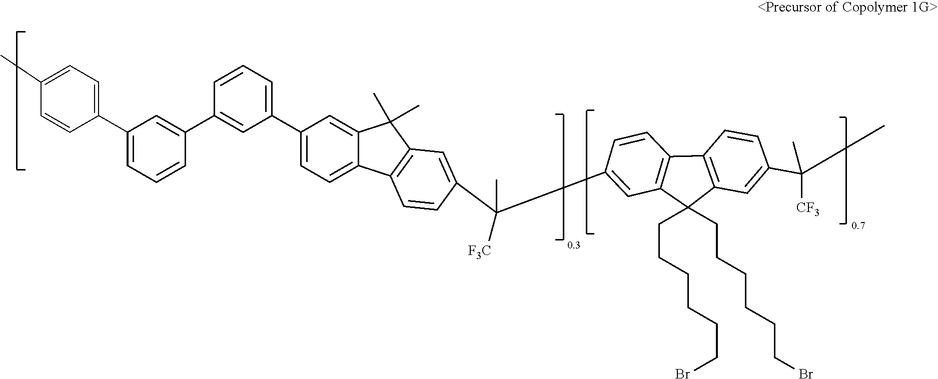

### (2) Preparation of Copolymer 1G

The precursor of Copolymer 1G (1.14 g) and dimethylformamide (9.9 mL) were added to a 25 mL round-bottom flask and stirred to prepare a solution. After the precursor of Copolymer 1G was completely dissolved, a 43% aqueous trimethylamine solution (1.8 mL) was slowly added. The mixture was stirred at room temperature for 48 hours and then poured into diethyl ether (120 mL) to precipitate a solid. The precipitated solid was filtered, washed twice with 70 mL of diethyl ether, and dried in an oven to obtain 1.18 g of Copolymer 1G.

Copolymer 1G includes the repeating unit represented by Formula 1G below.

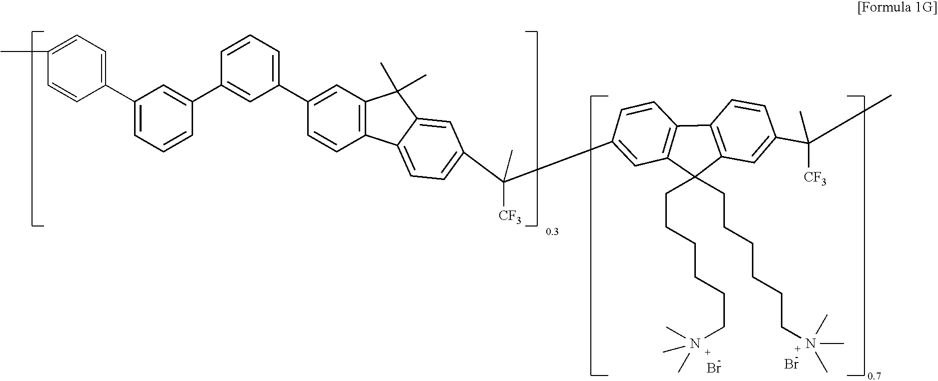

### Comparative Example 1 (Copolymer H)

9,9-Dimethylfluorene (0.24 g 1.24 mmol), 9,9-bis(6-bromohexyl)-9H-fluorene (0.79 g, 1.60 mmol), and dichloromethane (17.0 mL) were added to a 100 mL round-bottom flask and stirred to prepare a solution. The solution was cooled to 0° C. in a cooling water bath, and the solution was stirred at 0° C. under a nitrogen atmosphere. 1,1,1-trifluoroacetone (0.38 mL, 4.26 mmol) and trifluoromethanesulfonic acid (0.71 mL, 8.02 mmol) were then added. The resulting mixture was stirred at 0° C. for 2 hours, and the viscous solution was poured into methanol (200 mL) to precipitate a solid. The precipitated solid was filtered, washed twice with 50 mL of methanol, and dried in an oven to obtain 1.20 g of the precursor of Copolymer H.

The precursor of Copolymer H (1.20 g) and N-methyl-2-pyrrolidone (13.3 mL) were added to a 50 mL round-bottom flask and stirred to prepare a solution. After the precursor of Copolymer H was completely dissolved, a 43% aqueous solution of trimethylamine (2.49 mL) was slowly added. The mixture was stirred at room temperature for 48 hours, and the solution was poured into ethyl acetate (200 mL) to precipitate a solid. The precipitated solid was filtered, washed twice with 50 mL of ethyl acetate, and dried in an oven to obtain 1.18 g of Copolymer H.

Copolymer H includes the repeating unit represented by Formula H below:

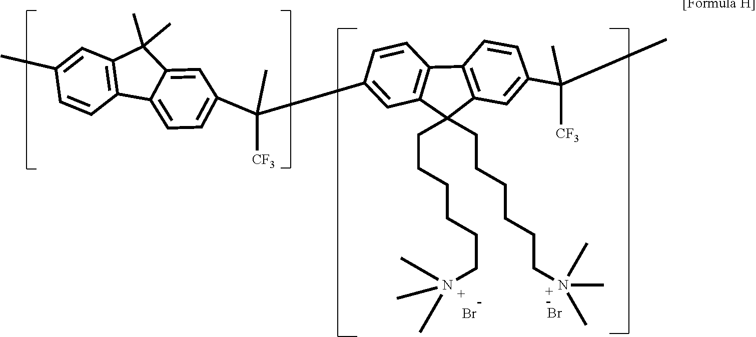

### Comparative Example 2

Sustainion® X37-50 Grade RT from Dioxide Materials was used as an anion exchange membrane.

### Comparative Example 3

Sustainion® X37-50 Grade T from Dioxide Materials was used as an anion exchange membrane.

### Experimental Example

### <Preparation of Ion Exchange Membrane>

(1) Anion exchange membranes were prepared using the copolymers synthesized in the above-described examples and comparative examples, as follows:

Specifically, each prepared copolymer was dissolved in N-methyl-2-pyrrolidone, filtered through a 5 μm syringe filter to remove impurities, and then cast onto a glass plate using a blade. The solvent was removed by evaporation in an 80° C. oven, followed by drying and the membrane was peeled off from the glass plate with distilled water to obtain an anion exchange membrane.

(2) The obtained anion exchange membrane may be used by immersing it in a 1 M potassium hydroxide aqueous solution to convert the anions to OH⁻. The membrane prepared in (1) above was immersed in a 1 M KOH aqueous solution at room temperature for 24 hours to convert the anions into OH⁻.

### Experimental Example 1: Room-Temperature Ionic Conductivity

The ionic conductivity (σ) of the anion exchange membrane was evaluated at room temperature (25° C.) in triple-distilled water using a membrane in the OH⁻ form as follows:

The anion exchange membrane was cut into 1 cm×3 cm samples and secured between Pt electrodes of a conductivity clamp (BT-110, Scribner).

The resistance (R) of each membrane sample was measured by the four-point probe method using an impedance analyzer (VSP-3e, Biologics) in the frequency range of 0.1 kHz to 1 MHz at room temperature. The thickness (T) of the membrane was measured using a micrometer gauge in a wet state, and the minimum measurement unit of the micrometer was 1 μm.

The ionic conductivity (σ)(C₁) was calculated according to Equation 2 below.

$$σ = \frac{L}{R \times A} = \frac{L}{R \times W \times T} \qquad [ Equation 2 ]$$

In Equation 2, R denotes the membrane resistance (Ω), A denotes the membrane cross-sectional area (cm²), L denotes the distance between the electrodes (cm), W denotes the width of the membrane sample (cm), and T denotes the membrane thickness (cm).

For reference, the ion-exchange capacity (IEC, mmol/g based on OH⁻) of the an ion exchange membrane was determined by converting the membrane into the OH form, cutting it into a predetermined size, reacting it with a standard acid solution of known concentration (e.g., 0.01 M HCl), and subsequently performing back-titration of the remaining acid with a standard base solution (e.g., 0.01 MNaOH). The IEC (mmol/g) was calculated by dividing the moles of acid consumed by the membrane by the dry weight of the membrane.

For reference, the ion-exchange capacity (IEC, mmol/g based on OH⁻) of the anion exchange membrane was determined by converting the membrane into the OH form, cutting it into a predetermined size, reacting it with a standard acid solution of known concentration (e.g., 0.01 M HCl), and subsequently performing back-titration of the remaining acid with a standard base solution (e.g., 0.01 MNaOH). The IEC (mmol/g) was calculated by dividing the moles of acid consumed by the membrane by the dry mass of the membrane. The membrane converted into the OH form was prepared by cutting a membrane in the X-form (primarily halide form) into a predetermined size, measuring its mass, and immersing it in a 1 M KOH aqueous solution for at least 24 hours to exchange the anions (X⁻→OH⁻). The dry membrane mass refers to the mass measured prior to immersion in the 1 M KOH aqueous solution.

The results are shown in Table 1 below.

TABLE 1

| | Ion-exchange | Thickness | Room-temperature |
|---|---|---|---|
| | capacity, IEC | (T) | ionic conductivity |
| Classification | (meq/g, OH⁻) | (μm) | (mS/cm) |
| Example 1 | 2.04 | 30 | 30.7 |
| Example 2 | 2.36 | 40 | 44.0 |
| Example 3 | 2.29 | 38 | 34.9 |
| Example 4 | 2.50 | 52 | 54.2 |
| Example 5 | 2.40 | 55 | 53.4 |
| Example 6 | 2.43 | 37 | 50.9 |
| Example 7 | 2.50 | 55 | 52.1 |
| Comparative | 2.50 | 50 | 32.7 |
| Example 1 | | | |
| Comparative | — | 50 | 38.0 |
| Example 2 | | | |
| Comparative | — | 50 | 32.7 |
| Example 3 | | | |

The room-temperature ionic conductivities of the anion exchange membranes according to the examples and comparative examples were all 30 mS/cm or more, indicating that they achieved sufficient ionic conductivity. Among the repeating units represented by Formula 1, those satisfying x<y and containing three phenylene groups exhibited higher room-temperature ionic conductivity, as observed in Examples 2 and 4 to 7. These data demonstrate that the inventive membranes demonstrate superior ionic conductivity due to their specific repeating unit structure.

### Experimental Example 2: High-Temperature Stability

The high-temperature stability of the anion exchange membranes prepared in Examples 4, 6, and Comparative Example 1 was evaluated as follows:

As described in Experimental Example 1, anion exchange membrane samples were prepared, immersed them in a 1 M KOH solution, and stored in an oven at 80° C.

The membrane samples were stored in an 80° C. oven for 7 days and/or 28 days, then removed, cooled to room temperature, and washed with triple-distilled water.

Then, ionic conductivity (C₂) was calculated using the same conditions and by the same method as described in Experimental Example 1.

The ionic conductivity (C₁) obtained in Experimental Example 1 and the ionic conductivity (C₂) obtained in Experimental Example 2 were substituted into Equation 1 below to calculate the reduction rate (R) of ionic conductivity.

$$Ionic conductivity reduction rate ( R , \% ) = ( ( {C}_{1} - {C}_{2} ) / {C}_{1} ) \times 100 \qquad [ Equation 1 ]$$

In Equation 1, C₁ denotes the ionic conductivity evaluated at room temperature for an anion exchange membrane including the copolymer for an anion exchange membrane, after converting the counterion to OH⁻, and C₂ denotes the ionic conductivity evaluated at room temperature after immersing the anion exchange membrane in the OH⁻ form in a 1 M alkaline solution, maintaining it at 80° C. for 28 days, and then cooling it to room temperature.

The results are shown in Table 2 below.

TABLE 2

| | | | | Ionic |
|---|---|---|---|---|
| | | | | conductivity |
| | Repeating | | Ionic | reduction |
| | unit | Duration | conductivity | rate (R) |
| Classification | (Formula) | (days) | (mS/cm) | (%) |
| Example 4 | Formula 1D | 1 | 54.2 | — |
| | | 28 | 55.1 | −1.7 |
| Example 6 | Formula 1F | 1 | 50.9 | — |
| | | 28 | 49.7 | 2.4 |
| Comparative | Formula H | 1 | 32.7 | — |
| Example 1 | | 7 | 27.2 | 16.8 |
| | | 14 | 23.0 | 29.7 |

The anion exchange membrane prepared in Example 4 showed a -1.7% change in ionic conductivity before and after 28 days of exposure at high temperature, indicating that the conductivity was maintained or slightly improved, thereby confirming its operational stability and reliability.

The anion exchange membrane prepared in Example 6 showed a 2.4% decrease in ionic conductivity before and after 28 days of exposure at high temperature, demonstrating enhanced chemical and physical stability, thereby confirming that operational stability and reliability were ensured.

The anion exchange membrane prepared in Comparative Example 1 exhibited an ionic conductivity decrease exceeding 15% even before 28 days of high-temperature exposure, that is, after only 7 and 14 days, indicating that the membrane had poor chemical and physical stability and thus failed to ensure operational stability and reliability. The embodiments of the present disclosure are described with reference to specific embodiments. However, the embodiments should not be construed as being limited only to the disclosed embodiments. It should be appreciated by those of ordinary skill in the art that other embodiments, and/or modified embodiments may be made without departing from the technical concepts and scope of the present disclosure. For example, features present in one embodiment may be used with one or more features of another embodiment without departing from the scope of the present disclosure. Furthermore, the embodiments may be combined to form additional embodiments.

What is claimed is:

1. A copolymer for an anion exchange membrane comprising a repeating unit represented by Formula 1 below: 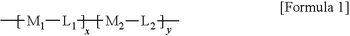
wherein in Formula 1, M₁ is selected from the arylene groups represented by any one of Formulae 2-1 and 2-2 below, M₂ is an arylene group represented by Formula 3 below, x and y are each independently 0.1 to 0.9 and x+y=1, and L₁ and L₂ are each independently selected from the arylene groups represented by Formulae 4-1 and 4-2 below, 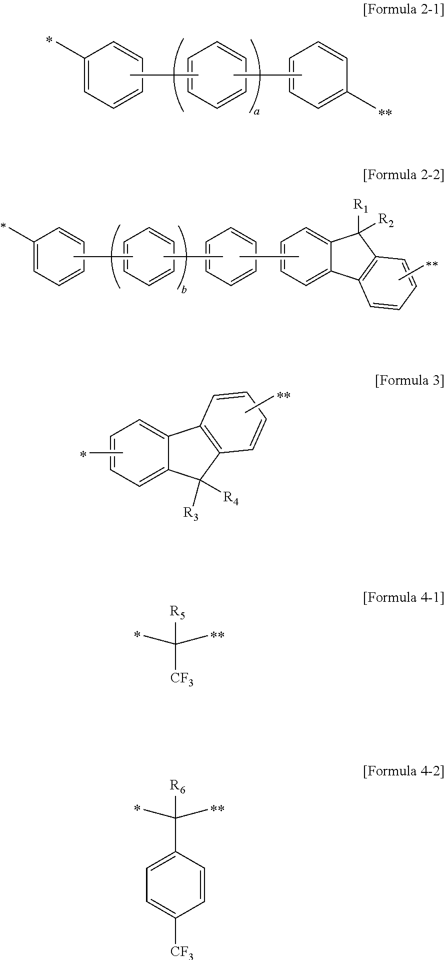
wherein in Formulae 2-1, 2-2, 3, 4-1, and 4-2,
a is an integer of 2 to 6, b is an integer of 0 to 4,
R₁ and R₂ are each independently a C₁-C₁₀ alkyl group,
R₃ and R₄ are each independently a C₃-C₁₀ alkyl group having a quaternary ammonium salt at a terminal,
R₅ and R₆ are each independently selected from —H and a C₁-C₃ alkyl group, and
-* and -*′ represent crosslinked bonding sites.

2. The copolymer for an anion exchange membrane according to claim 1, wherein in Formula 2-1, a is an integer of 2 to 5, and in Formula 2-2, b is an integer of 0 to 3.

3. The copolymer for an anion exchange membrane according to claim 1, wherein the divalent phenylene groups in Formulae 2-1 and 2-2 are each independently bonded at the meta- or para-position.

4. The copolymer for an anion exchange membrane according to claim 1, wherein the counterion of the quaternary ammonium salt is a halide anion, OH⁻, or HCO₃⁻.

5. The copolymer for an anion exchange membrane according to claim 1, wherein M₁ is selected from the arylene groups represented by any one of Formulae 2-1A to 2-1E below: 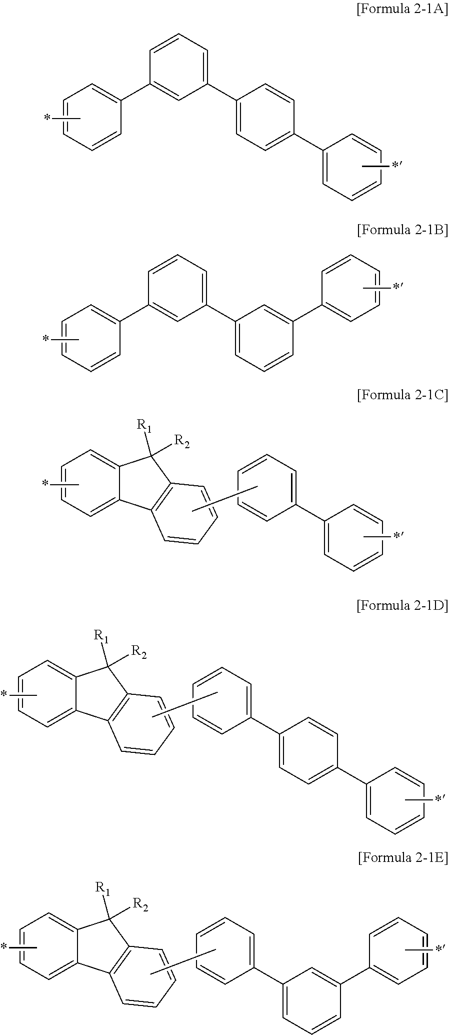
wherein n Formulae 2-1A to 2-1E, R₁ and R₂ are each independently a C₁-C₁₀ alkyl group, and -* and -*′ represent crosslinked bonding sites.

6. The copolymer for an anion exchange membrane according to claim 5, wherein in Formulae 2-1C to 2-1E, the arylene group derived from fluorene is bonded at the meta-position with respect to the adjacent phenylene group.

7. The copolymer for an anion exchange membrane according to claim 1, wherein R₁ and R₂ are each independently a C₁-C₅ alkyl group.

8. The copolymer for an anion exchange membrane according to claim 1, wherein R₃ and R₄ are each independently a C₄-C₇ alkyl group having a halide quaternary ammonium salt at a terminal.

9. The copolymer for an anion exchange membrane according to claim 1, wherein the quaternary ammonium salt is selected from the group represented by Formulae 5-1 to 5-3 below: 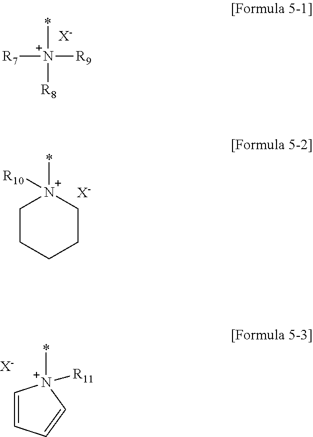
wherein in Formulae 5-1 to 5-3, R₇ to R₁₁ are each independently a C₁-C₅ alkyl group, each X is independently OH, F, Cl, Br, or I and -* represents a bonding site bonded to the terminal of R₃ or R₄.

10. The copolymer for an anion exchange membrane according to claim 1, wherein the copolymer further comprises a crosslinking unit represented by any one of Formulae 6-1 and 6-2 below: 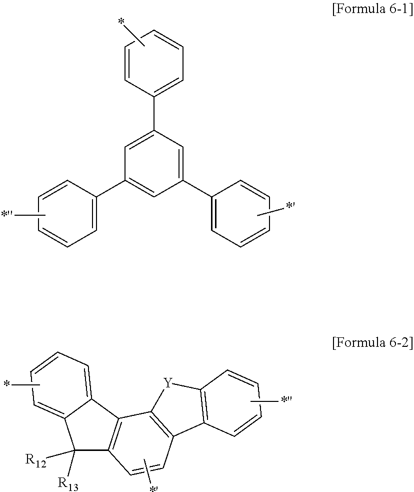
wherein in Formulae 6-1 and 6-2, -*, -*′ and -*″ represent bonding sites crosslinked with the repeating unit, R₁₂ and R₁₃ are each independently a C₁-C₅ alkyl group, and Y is O or S.

11. The copolymer for an anion exchange membrane according to claim 10, wherein the repeating unit and the crosslinking unit are directly crosslinked or are crosslinked through an arylene group represented by any one of Formulae 7-1 and 7-2 below: 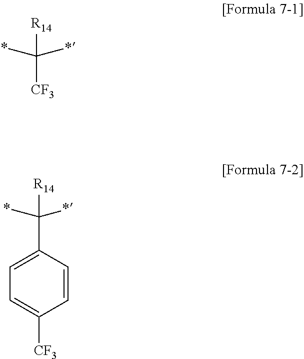
wherein in Formulae 7-1 and 7-2, R₁₄ and R₁₅ are each independently selected from —H and C₁-C₃ alkyl groups, and -* and -*′represent crosslinked bonding sites.

12. The copolymer for an anion exchange membrane according to claim 1, wherein the repeating unit represented by Formula 1 is in an amount of 90.0 mol % to 100 mol %, based on the total repeating units included in the copolymer.

13. The copolymer for an anion exchange membrane according to claim 10, wherein the repeating unit represented by Formula 1 is in an amount of 80.0 mol % to 99.0 mol %, based on the total repeating units included in the copolymer, and wherein the crosslinking unit represented by any one of Formulae 6-1 and 6-2 is in an amount of 1.0 mol % to 20.0 mol %, based on the total repeating units included in the copolymer.

14. The copolymer for an anion exchange membrane according to claim 1, wherein the copolymer has a weight average molecular weight of 30,000 g/mol to 2,000,000 g/mol.

15. The copolymer for an anion exchange membrane according to claim 1, wherein the ionic conductivity reduction rate (R), calculated by Equation 1 below, is 15% or less:
$$Ionic conductivity reduction rate ( R , \% ) = ( ( {C}_{1} - {C}_{2} ) / {C}_{1} ) \times 100 \qquad Equation 1$$
wherein in Equation 1, C₁ denotes the ionic conductivity evaluated at room temperature for an anion exchange membrane including the copolymer for an anion exchange membrane, after converting the counterion to OH⁻, and C₂ denotes the ionic conductivity evaluated at room temperature after immersing the anion exchange membrane in the OH⁻ form in a 1 M alkaline solution, maintaining it at 80° C. for 28 days, and then cooling it to room temperature.

16. An anion exchange membrane comprising the copolymer for an anion exchange membrane according to claim 1.

17. The anion exchange membrane according to claim 16, wherein the anion exchange membrane has a thickness of 10 μm to 80 μm.

18. The anion exchange membrane according to claim 16, wherein the OH⁻ ionic conductivity measured at room temperature for the copolymer for the anion exchange membrane is 30 mS/cm or more.

19. A copolymer for an anion exchange membrane comprising a repeating unit represented by Formula 1 below: 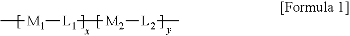
wherein in Formula 1, M₁ is selected from the arylene groups represented by any one of Formulae 2-1 and 2-2 below, M₂ is an arylene group represented by Formula 3 below, x and y are each independently 0.1 to 0.9 and x+y=1, and L₁ and L₂ are each independently selected from the arylene groups represented by Formulae 4-1 and 4-2 below, 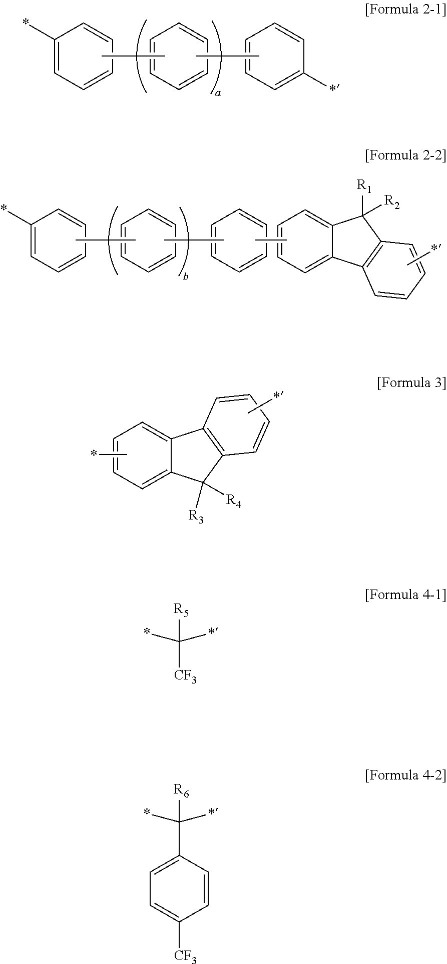
wherein in Formulae 2-1, 2-2, 3, 4-1, and 4-2,
a is an integer of 2 to 6, b is an integer of 0 to 4,
R₁ and R₂ are each independently a C₁-C₁₀ alkyl group,
R₃ and R₄ are each independently a C₃-C₁₀ alkyl group having a quaternary ammonium salt at a terminal,
R₅ and R₆ are each independently selected from —H and a C₁-C₃ alkyl group, and
-* and -*′ represent crosslinked bonding sites,
wherein the counterion of the quaternary ammonium salt is a halide anion, OH—, or HCO3-, and
wherein the copolymer has a weight average molecular weight of 30,000 g/mol to 2,000,000 g/mol.
